(19) United States
(12) Patent Application Publication
(10) Pub. No.: US 2026/0190128 A1
(43) Pub. Date: Jul. 2, 2026

(54) SYSTEMS AND METHODS FOR ALLOCATING SERVICE USAGE

(71) Applicant: Verizon Patent and Licensing Inc., Basking Ridge, NJ (US)

(72) Inventors: Firas B. Arabo, Spring Valley, CA (US); Karthi V. Tamilveeran, San Diego, CA (US); Benson Wai Kit Ly, San Francisco, CA (US); Chintan Sheth, San Diego, CA (US); Elena Barabatko, Wesley Chapel, FL (US)

(21) Appl. No.: 19/006,831

(22) Filed: Dec. 31, 2024

(51) Int. Cl. H04W 72/51; H04W 72/54

(52) U.S. Cl. CPC H04W 72/51; H04W 72/54

(57) ABSTRACT

A method includes controlling services for a first device in a first group based on a first service allocation for the first group during a first portion of an interval, controlling services for a second device in a second group based on a second service allocation for the second group during the first portion, determining a first individual usage metric for the first device, determining a first group usage metric for the first group, transferring the first device from the first group to the second group responsive to the first group usage metric exceeding the first service allocation, and controlling services for the first device in the second group based on the second service allocation during a second portion of the interval.

### BACKGROUND

Wireless networks may provide services to User Equipment (UE), such as mobile telephones, Internet of Things (IoT) devices, or other wireless devices. A UE may be associated with a profile, a group of devices, a set of service usage plans, or other suitable information, which it can utilize to access a specific wireless network provided by a particular carrier.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram of a communication system, according to some embodiments.

FIGS. 2 and 3 are diagrams illustrating user equipment service usage allocation, according to some embodiments.

FIG. 4 is a flow chart illustrating an example method for allocating services, according to some embodiments.

FIG. 5 is an illustration of a scenario involving various examples of transmission mediums that may be used to communicatively couple computers and clients.

FIG. 6 is an illustration of a scenario involving an example configuration of a computer that may utilize and/or implement at least a portion of the techniques presented herein.

FIG. 7 is an illustration of a scenario involving an example configuration of a client that may utilize and/or implement at least a portion of the techniques presented herein.

FIG. 8 is an illustration of a scenario featuring an example non-transitory machine-readable medium in accordance with one or more of the provisions set forth herein.

FIG. 9 is an illustration of an example environment in which at least a portion of the techniques presented herein may be utilized and/or implemented.

FIG. 10 is an illustration of an example network that may utilize and/or implement at least a portion of the techniques presented herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of computing scenarios in which the disclosed subject matter may be utilized and/or implemented.

In some embodiments, a method includes controlling services provided to a first device in a first group of devices based on a first service allocation for the first group during a first portion of a first service interval, determining a first individual usage metric for the first device for the first service interval, determining a first group usage metric for the first group of devices for the first service interval, transferring the first device from the first group of devices to a second group of devices responsive to the first group usage metric exceeding the first service allocation, and controlling services provided to the first device in the second group based on the second service allocation during a second portion, different than the first portion, of the first service interval.

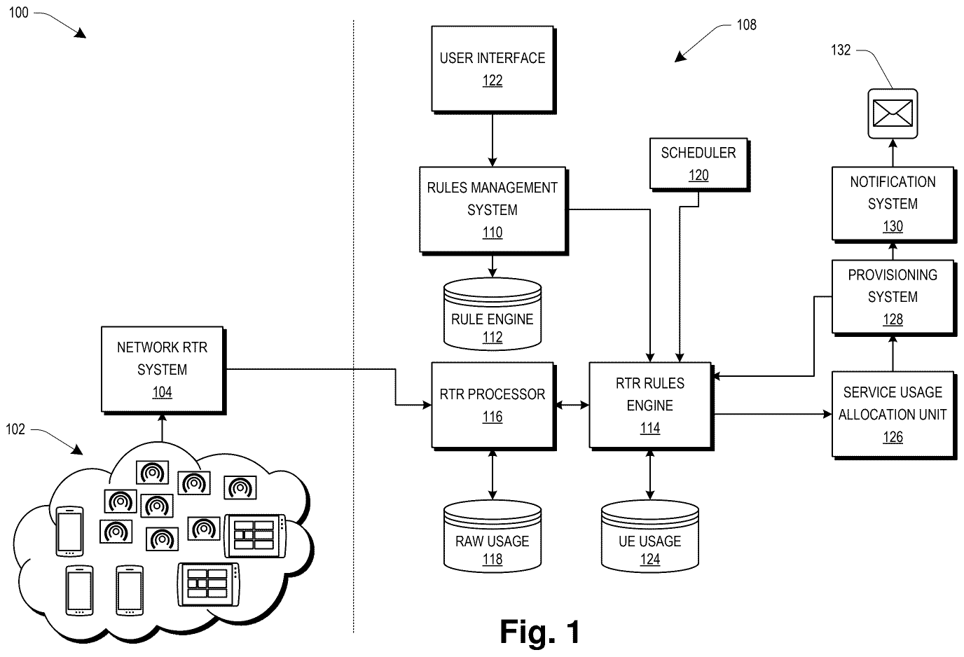

FIG. 1 is a diagram of a communication system 100, according to some embodiments. The communication system 100 comprises user equipment devices (UEs) 102 operating in a network environment, such as in a cellular network environment, one or more network real-time reporting (RTR) systems 104 that collect data, such as service usage data (e.g., data received/transmitted, number of connections, duration of connections), regarding the UEs 102. In some embodiments, the UE 102 may include mobile telephones, Internet of Things (IoT) devices, tablets, or other wireless devices.

UEs 102 may be associated with a customer of a network service provider, and a particular customer may use one or more subscriber entities to allow separate management of device groups. The UEs 102 for a particular subscriber entity are assigned to groups depending on allocated service usage for a particular service interval. For example, each UE 102 in a group may be allocated the same service usage for the service interval and the total allocation for the group is determined by the per UE allocation times the number of UEs 102 in the group. The number of groups, the allocated service usage for each group, and the number of UEs 102 in each group may vary. In some instances, the subscriber entity may have millions of UEs 102 assigned to groups. The UEs 102 are initially assigned to groups based on their expected service usage for the service interval. In some embodiments, the subscriber entity may assign the UEs 102 to the groups by interfacing with the rules management system using a user interface 122, such as a ThingSpace Management (TSM) portal for IoT devices, a Unified Web Services Simple Object Access Protocol API (UWM SOAP API), a Representational State Transfer (REST) API, or some other user interface.

In some situations, UEs assigned to a group may overuse their service allocation during a service interval. For example, UEs in a group may transmit more data than was allocated to the UE or group based on the expected usage level, or may attempt more network connections than expected. This may result in penalties from the service provider, as the service provider has allocated resources to the subscriber based on the expected usage. Service providers may track usage data on a per UE or per group basis to ensure compliance with allocation levels.

However, where a subscriber has multiple groups of UEs, it is possible that during a given service interval, one group of UEs is experiencing an overuse of allocated resources while another group of UEs is experiencing an underuse of allocated resources. Additionally, with sufficient advance notice, it may be possible to increase/decrease the allocated resources of certain groups to accommodate unexpected usage changes, and thereby avoid overuse penalties.

In some embodiments, the supervisory system 108 comprises a rules management system 110 that manages a rule engine database 112 for storing RTR event triggers, a RTR rules engine 114 that implements the RTR rules, a RTR processor 116 that receives reporting data from the network RTR system 104 and stores reported data regarding the UEs 102 in a raw usage database 118. In some embodiments, the RTR processor 116 and the RTR rules engine 112 implement an Intelligence Alert Engine that provides a set of microservices that allows effective service usage management of devices by providing a set of alerts that give users real time detection alerts based on the amount of service usage (e.g., percentage of usage based on allocation for a service interval), aggregated service usage at various levels, and a set of APIs that provide services to devices, accounts, users, groups, and configuration data.

In some embodiments, the supervisory system 108 comprises a scheduler 120 that triggers a service usage analysis for a subscriber entity by the RTR rules engine 114. In an example, the scheduler 120 triggers the service usage analysis for the subscriber entity by the RTR rules engine 114 near an end of the service interval (e.g., 24 hours before) to allow automatic usage balancing for the UEs 102 to avoid exceeding allocated service usage for one or more groups. In response to the service usage analysis trigger, the RTR rules engine 114 requests raw usage data for the associated UEs 102 from the raw usage database 118 and stores the usage data by UE 102 in a UE usage database 124.

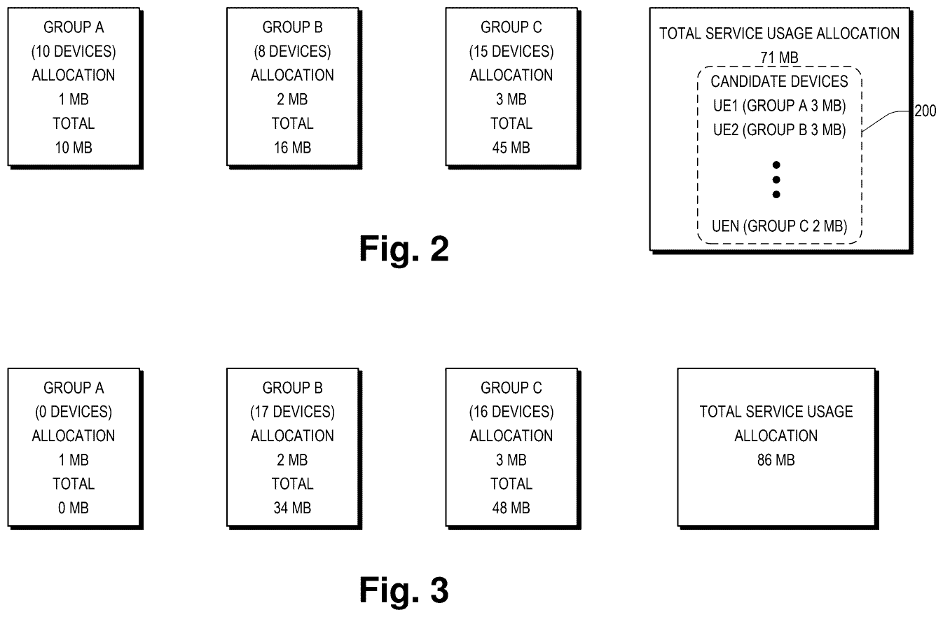

FIGS. 2 and 3 are diagrams illustrating an example of user equipment service usage allocation, according to some embodiments. In some embodiments, a service usage allocation unit 126 determines aggregated UE 102 service usage (in this example, data usage) by group. FIG. 2 illustrates an example of 33 UEs assigned among three service usage groups (Group A, Group B, Group C) based on their expected data usage. In the example of FIG. 2, ten UEs 102 may be in Group A because they are expected to consume up to 1 MB of data in a service interval, and therefore may be each allocated 1 MB of data usage for the service interval resulting in a total group usage allocation of 10 MB, eight UEs 102 may be in Group B because they are expected to consume between 1 MB and 2 MB of data in the service interval and therefore may be each allocated 2 MB of data usage for the service interval resulting in a total allocation of 16 MB, and 15 UEs 102 may be in Group C because they are expected to consume between 2 MB and 3 MB of data in the service interval, and therefore may be each allocated 3 MB of data usage for the service interval resulting in a total allocation of 45 MB. In the example of FIG. 2, the total allocation determined by the service usage allocation unit 126 for all of the groups is 71 MB.

The service usage allocation unit 126 may combine the data usage by UE 102 for a first portion of the service interval represented by the data in the UE usage database 124 with an estimated data usage by UE 102 for the remainder of the service interval by extrapolating the usage by UE 102 over the first portion of the service interval or based on the recent usage (e.g., last day, last week, or some other window of the first portion of the service interval) to generate an individual usage metric for the UE 102

The service usage allocation unit 126 compares the total allocation to the individual and group service usage metrics for the service interval (e.g., actual plus estimated) and identifies usage exceeding the allocation by device, group, and total. Assuming the usage for the UEs 102 for the service interval exceeds the service allocation, the service usage allocation unit 126 rebalances the groups to avoid overage penalties by either (a) moving UEs among the groups such that the service usage on a per-group basis remains within existing per-group allowances, or (b) moving UEs to groups with higher per-UE usage allowances, which may avoid overage penalties but increase per-group usage allowances - resulting in additional service cost to the customer, but less than might be incurred from overage penalties. For the example of FIGS. 2 and 3, the usage of all UEs in group A may be projected to be over the 0-1 MB allocation, while the usage of one of the UEs in Group B may be projected to be over the 1 MB-2 MB allocation.

The service usage allocation unit 126 generates a candidate list 200 of UEs 102 (e.g., UE1 to UEN) based on usage and group assignment. The service usage allocation unit 126 reassigns the UEs 102 to the groups based on the candidate list 200. UEs 102 that have exceeded their individual data usage allocations are moved to groups with higher individual data usage allocations and UEs 102 that have underused their data usage allocations may be moved to groups with lower individual data usage allocations. These reassignments may be subject to adjustment as noted below.

The reallocation of the UEs 102 to different groups may be subject to constraints that limit the reallocation process. For example, the total service usage allocation may be constrained from increasing (or decreasing) by a predetermined balancing limit, such as 20%, or a range, such as 20% 22%. Each group may have an associated cost metric, and the service usage allocation unit 126 may perform the rebalancing subject to an optimization function that minimizes the total cost. The subscriber entity may set the constraints using the user interface 122. In a situation where all of the UEs 102 cannot be moved to different groups without exceeding the predetermined balancing limit, the constraint of not exceeding the total data usage allocation for each group may not be possible to meet. In some embodiments, constrains may limit the total service allocation permitted to a group or groups, such that reassignments of UEs to a group that result in a total service allocation above the group's allowed total service usage allocation may need to be adjusted.

In some embodiments, the service usage allocation unit 126 may employ an iterative process for rebalancing the groups. The candidate UEs 102 may be tentatively transferred to different groups during the iterative process. For example, if the group service usage for a given group exceeds the allowed group total service usage allocation after tentatively transferring a candidate UE 102, the transfer may be prevented or the candidate UE 102 may be transferred to a different group with a higher service usage allocation per UE 102 and additional available total usage allocation. The iterative rebalancing may continue until all constraints are met - in this example, the group service usage for each group does not exceed its allowed group service usage allocation and the predetermined balancing limit has been met. In some embodiments, the iterative process may continue for a threshold number of iterations (or time), and if no constraint-compliant reallocation is found, the reallocation process is terminated without reallocating UEs 102.

FIG. 3 illustrates the three data usage groups (Group A, Group B, Group C) after rebalancing. In the example of FIG. 3, no UEs 102 are now in Group A. 17 UEs 102 are now in Group B and each are allocated 2 MB of data usage for the service interval, resulting in a total allocation of 34 MB for Group B. 16 UEs 102 are now in Group C and each are allocated 3 MB of data usage for the service interval, resulting in a total allocation of 48 MB for Group C. The overall data usage allocation after rebalancing is 86 MB, representing an increase in total data usage allocation of 17 MB, which is a 21.1% increase over the original total usage allocation. While the group allocations for each of Group B and Group C have increased, the allocations are within the allowed total group service usage allocations for those groups.

After rebalancing the groups, the service usage allocation unit 126 communicates the new usage allocations to a provisioning system 128. In some embodiments, the provisioning system 128 controls delivery of services to the UEs 102 based on the new service usage allocations. For example, the provisioning system 128 may interface with network functions such as a charging function to adjust per-UE or per-group service parameters, and notification system 130 that sends a notification 132 to one or more designated individuals for the subscriber entity.

The rebalanced groups may be in effect for the remainder of the service interval. In some embodiments, the rebalancing may remain in effect for the next service interval until the triggering of the next rebalancing. In some embodiments, the groups may reset to the original group configurations at the start of a service interval.

Although the example provided in FIGS. 2 and 3 illustrated rebalancing using a data usage metric, rebalancing can be based on other service metrics, and control of the delivery of services based on those service metrics can vary. For example, service can be tracked and rebalanced based on: number of connections, duration of connections, types of connection requests, and the like. Additionally, controlling the services provided to the UEs 102 may include adjusting service parameters such as: a Quality of Service (QoS) parameter, adjusting an assigned bandwidth, adjusting limits on connection frequency or duration, allocating a cost, or some other control parameter. Different groups may have different control parameters, such as different QoS parameters, different bandwidth (e.g., data rate) parameters, etc.

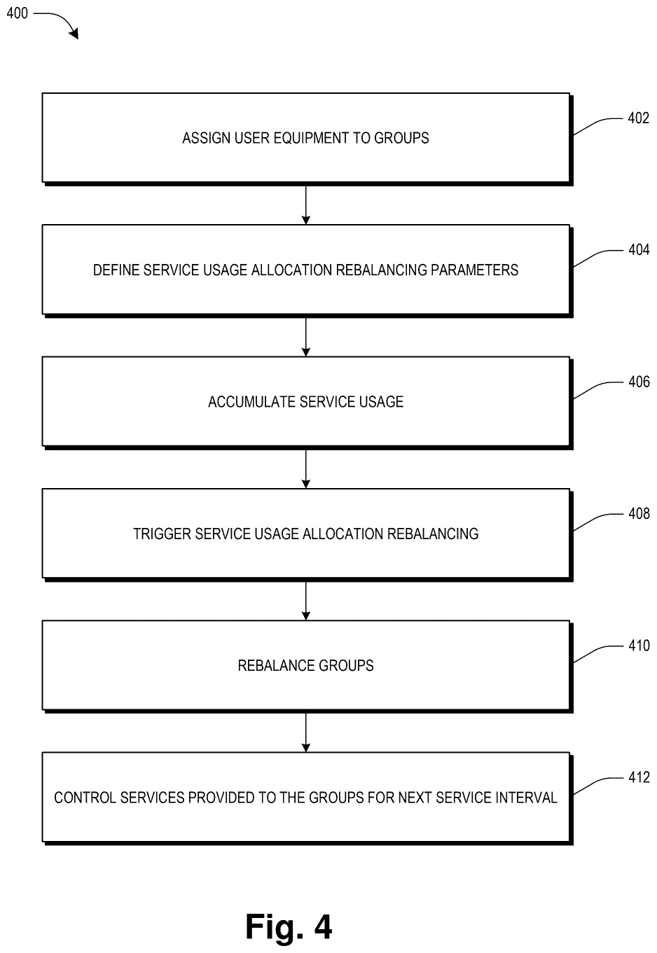

FIG. 4 is a flow chart illustrating an example method 400 for allocating services, according to some embodiments. At 402 a subscriber entity assigns UEs 102 to groups. Each group may have a different service usage allocation. At 404, service usage allocation rebalancing parameters are set, such as enabling rebalancing, the timing of the rebalancing trigger event with respect to the service interval, the predetermined balancing limit, or other parameters. The service usage allocation rebalancing parameters may result in rules being set in the rule engine database 112 for the scheduler 120 or the service usage allocation unit 126. At 406 service usage is accumulated. For example, raw usage data may be received by the RTR processor and stored in the raw usage database 118. At 408, a service usage allocation rebalancing is triggered, for example, by the scheduler 120 based on a rule in the rule engine database 112. At 410, the groups are rebalanced by the service usage allocation unit 126. The service usage allocation unit 126 may accumulate UE usage data in the UE usage database 124 by UE 102 and group and identify the candidate list 200. The service usage allocation unit 126 may perform the rebalancing optimization based on rules in the rule engine database 112, such as the predetermined balancing limit. At 412, the services provided to the UEs 102 in the groups are controlled for next service interval (and the remainder of the current service interval).

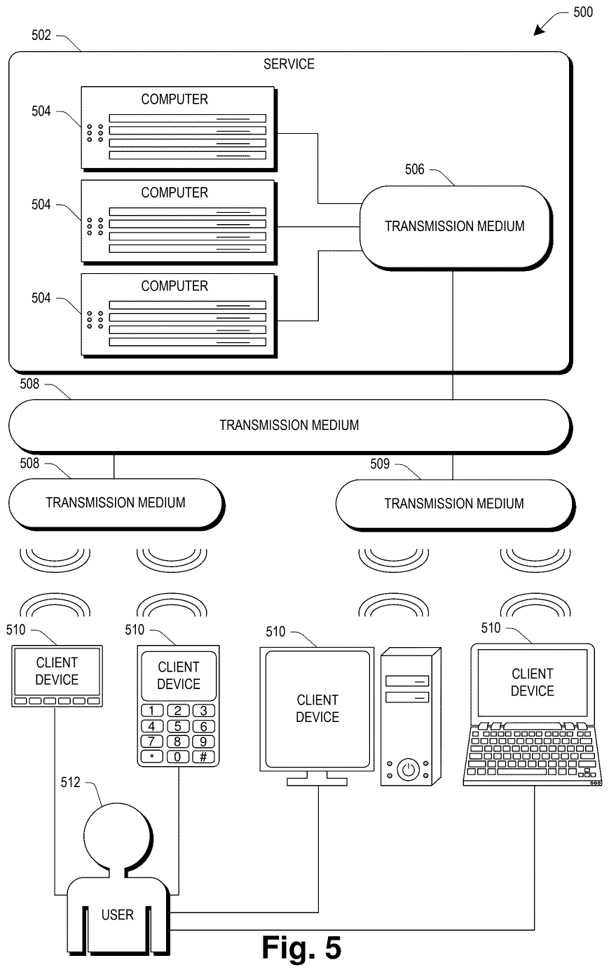

FIG. 5 is an interaction diagram of a scenario 500 illustrating a service 502 provided by a set of computers 504 to a set of client devices 510 via various types of transmission mediums. The computers 504 and/or client devices 510 may be capable of transmitting, receiving, processing, and/or storing many types of signals, such as in memory as physical memory states.

The computers 504 of the service 502 may be communicatively coupled together, such as for exchange of communications using a transmission medium 506. The transmission medium 506 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 502.

Likewise, the transmission medium 506 may comprise one or more sub-networks, such as may employ different architectures, may be compliant or compatible with differing protocols and/or may interoperate within the transmission medium 506. Additionally, various types of transmission medium 506 may be interconnected (e.g., a router may provide a link between otherwise separate and independent transmission medium 506).

In scenario 500 of FIG. 5, the transmission medium 506 of the service 502 is connected to a transmission medium 508 that allows the service 502 to exchange data with other services 502 and/or client devices 510. The transmission medium 508 may encompass various combinations of devices with varying levels of distribution and exposure, such as a public wide-area network and/or a private network (e.g., a virtual private network (VPN) of a distributed enterprise).

In the scenario 500 of FIG. 5, the service 502 may be accessed via the transmission medium 508 by a user 512 of one or more client devices 510, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 510 may communicate with the service 502 via various communicative couplings to the transmission medium 508. As a first such example, one or more client devices 510 may comprise a cellular communicator and may communicate with the service 502 by connecting to the transmission medium 508 via a transmission medium 507 provided by a cellular provider. As a second such example, one or more client devices 510 may communicate with the service 502 by connecting to the transmission medium 508 via a transmission medium 509 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 504 and the client devices 510 may communicate over various types of transmission mediums.

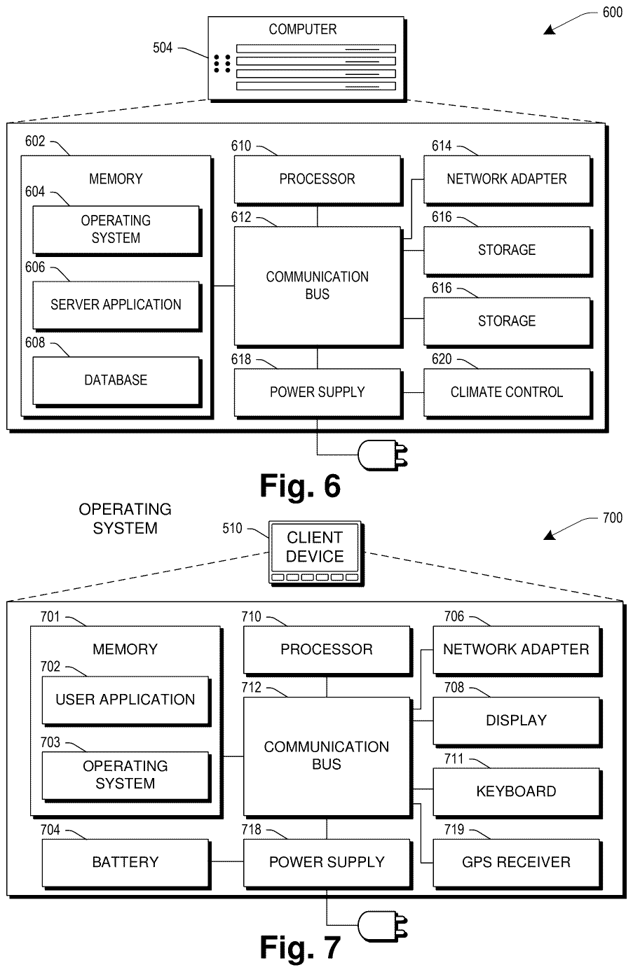

FIG. 6 presents a schematic architecture diagram 600 of a computer 604 that may utilize at least a portion of the techniques provided herein. Such a computer 604 may vary widely in configuration or capabilities, alone or in conjunction with other computers, in order to provide a service such as the service 502.

The computer 604 may comprise one or more processors 610 that process instructions. The one or more processors 610 may optionally include a plurality of cores; one or more coprocessors, such as a mathematics coprocessor or an integrated graphical processing unit (GPU); and/or one or more layers of local cache memory. The computer 504 may comprise memory 602 storing various forms of applications, such as an operating system 604; one or more computer applications 606; and/or various forms of data, such as a database 608 or a file system. The computer 604 may comprise a variety of peripheral components, such as a wired and/or wireless network adapter 614 connectible to a local area network and/or wide area network; one or more storage components 616, such as a hard disk drive, a solid-state storage device (SSD), a flash memory device, and/or a magnetic and/or optical disk reader.

The computer 604 may comprise a mainboard featuring one or more communication buses 612 that interconnect the processor 610, the memory 602, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 612 may interconnect the computer 604 with at least one other computer. Other components that may optionally be included with the computer 604 (though not shown in the schematic architecture diagram 600 of FIG. 6) include a display; a display adapter, such as a graphical processing unit (GPU); input peripherals, such as a keyboard and/or mouse; and a flash memory device that may store a basic input/output system (BIOS) routine that facilitates booting the computer 604 to a state of readiness.

The computer 604 may operate in various physical enclosures, such as a desktop or tower, and/or may be integrated with a display as an “all-in-one” device. The computer 604 may be mounted horizontally and/or in a cabinet or rack, and/or may simply comprise an interconnected set of components. The computer 604 may comprise a dedicated and/or shared power supply 618 that supplies and/or regulates power for the other components. The computer 604 may provide power to and/or receive power from another computer and/or other devices. The computer 604 may comprise a shared and/or dedicated climate control unit 620 that regulates climate properties, such as temperature, humidity, and/or airflow. Many such computers 604 may be configured and/or adapted to utilize at least a portion of the techniques presented herein.

FIG. 7 presents a schematic architecture diagram 700 of a client device 710 whereupon at least a portion of the techniques presented herein may be implemented. Such a client device 710 may vary widely in configuration or capabilities, in order to provide a variety of functionality to a user such as the user 512. The client device 710 may be provided in a variety of form factors, such as a desktop or tower workstation; an “all-in-one” device integrated with a display 708; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 709 that process instructions. The one or more processors 709 may optionally include a plurality of cores; one or more coprocessors, such as a mathematics coprocessor or an integrated graphical processing unit (GPU); and/or one or more layers of local cache memory. The client device 710 may comprise memory 701 storing various forms of applications, such as an operating system 703; one or more user applications 702, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 706 connectible to a local area network and/or wide area network; one or more output components, such as a display 708 coupled with a display adapter (optionally including a graphical processing unit (GPU)), a sound adapter coupled with a speaker, and/or a printer; input devices for receiving input from the user, such as a keyboard 711, a mouse, a microphone, a camera, and/or a touch-sensitive component of the display 708; and/or environmental sensors, such as a global positioning system (GPS) receiver 719 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 700 of FIG. 7) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 712 that interconnect the processor 709, the memory 701, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 718 that supplies and/or regulates power for other components, and/or a battery 704 that stores power for use while the client device 710 is not connected to a power source via the power supply 718. The client device 710 may provide power to and/or receive power from other client devices.

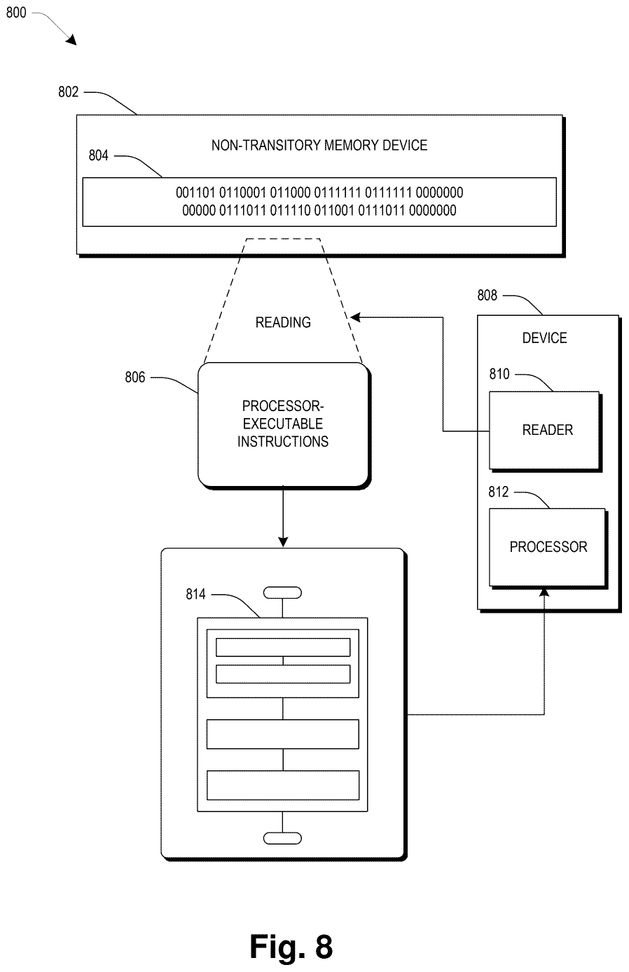

FIG. 8 is an illustration of a scenario 800 involving an example non-transitory machine-readable medium 802. The non-transitory machine-readable medium 802 may comprise processor-executable instructions 812 that when executed by a processor 816 cause performance (e.g., by the processor 816) of at least some of the provisions herein. The non-transitory machine-readable medium 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine-readable medium 802 stores machine-readable data 804 that, when subjected to reading 806 by a reader 810 of a device 808 (e.g., a read head of a hard disk drive, or a read operation invoked on a solid-state storage device), express the processor-executable instructions 812. In some embodiments, the processor-executable instructions 812, when executed cause performance of operations, such as at least some of the example method 400 of FIG. 4, for example. In some embodiments, the processor-executable instructions 812 are configured to cause implementation of a system.

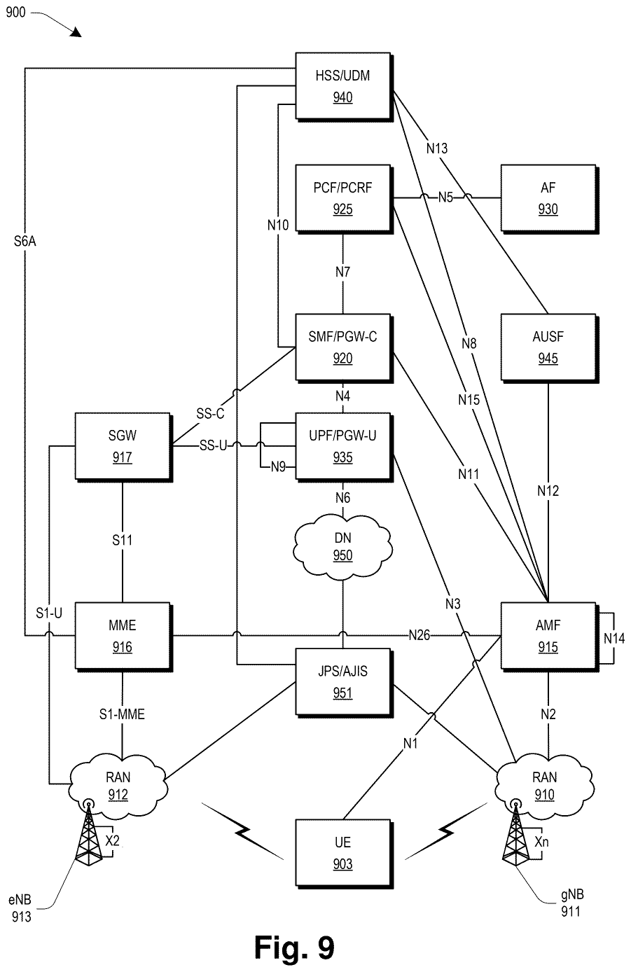

FIG. 9 illustrates an example environment 900, in which one or more embodiments may be implemented. In some embodiments, environment 900 may correspond to a Fifth Generation (“5G”) network, and/or may include elements of a 5G network. In some embodiments, environment 900 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 900 may include UE 903, RAN 910 (which may include one or more Next Generation Node Bs (“gNBs”) 911), RAN 912 (which may include one or more one or more evolved Node Bs (“eNBs”) 913), and various network functions such as Access and Mobility Management Function (“AMF”) 915, Mobility Management Entity (“MME”) 916, Serving Gateway (“SGW”) 917, Session Management Function (“SMF”)/Packet Data Network (“PDN”) Gateway (“PGW”)-Control plane function (“PGW-C”) 920, Policy Control Function (“PCF”)/Policy Charging and Rules Function (“PCRF”) 925, Application Function (“AF”) 930, User Plane Function (“UPF”)/PGW-User plane function (“PGW-U”) 935, Home Subscriber Server (“HSS”)/Unified Data Management (“UDM”) 940, and Authentication Server Function (“AUSF”) 945. Environment 900 may also include one or more networks, such as Data Network (“DN”) 950. Environment 900 may include one or more additional devices or systems communicatively coupled to one or more networks (e.g., DN 950), such as client-side router 951.

The example shown in FIG. 9 illustrates one instance of each network component or function (e.g., one instance of SMF/PGW-C 920, PCF/PCRF 925, UPF/PGW-U 935, HSS/UDM 940, and/or 945). In practice, environment 900 may include multiple instances of such components or functions. For example, in some embodiments, environment 900 may include multiple “slices” of a core network, where each slice includes a discrete set of network functions (e.g., one slice may include a first instance of SMF/PGW-C 920, PCF/PCRF 925, UPF/PGW-U 935, HSS/UDM 940, and/or 945, while another slice may include a second instance of SMF/PGW-C 920, PCF/PCRF 925, UPF/PGW-U 935, HSS/UDM 940, and/or 945). The different slices may provide differentiated levels of service, such as service in accordance with different Quality of Service (“QoS”) parameters.

The quantity of devices and/or networks, illustrated in FIG. 9, is provided for explanatory purposes only. In practice, environment 900 may include additional devices and/or networks, fewer devices and/or networks, different devices and/or networks, or differently arranged devices and/or networks than illustrated in FIG. 9. For example, while not shown, environment 900 may include devices that facilitate or enable communication between various components shown in environment 900, such as routers, modems, gateways, switches, hubs, etc. Alternatively and/or additionally, one or more of the devices of environment 900 may perform one or more network functions described as being performed by another one or more of the devices of environment 900. Devices of environment 900 may interconnect with each other and/or other devices via wired connections, wireless connections, or a combination of wired and wireless connections. In some implementations, one or more devices of environment 900 may be physically integrated in, and/or may be physically attached to, one or more other devices of environment 900.

UE 903 may include a computation and communication device, such as a wireless mobile communication device that is capable of communicating with RAN 910, RAN 912, and/or DN 950. UE 903 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Mobile-to-Mobile (“M2M”) device, or another type of mobile computation and communication device. UE 903 may send traffic to and/or receive traffic (e.g., user plane traffic) from DN 950 via RAN 910, RAN 912, and/or UPF/PGW-U 935.

RAN 910 may be, or may include, a 5G RAN that includes one or more base stations (e.g., one or more gNBs 911), via which UE 903 may communicate with one or more other elements of environment 900. UE 903 may communicate with RAN 910 via an air interface (e.g., as provided by gNB 911). For instance, RAN 910 may receive traffic (e.g., voice call traffic, data traffic, messaging traffic, signaling traffic, etc.) from UE 903 via the air interface, and may communicate the traffic to UPF/PGW-U 935, and/or one or more other devices or networks. Similarly, RAN 910 may receive traffic intended for UE 903 (e.g., from UPF/PGW-U 935, AMF 915, and/or one or more other devices or networks) and may communicate the traffic to UE 903 via the air interface.

RAN 912 may be, or may include, a LTE RAN that includes one or more base stations (e.g., one or more eNBs 913), via which UE 903 may communicate with one or more other elements of environment 900. UE 903 may communicate with RAN 912 via an air interface (e.g., as provided by eNB 913). For instance, RAN 910 may receive traffic (e.g., voice call traffic, data traffic, messaging traffic, signaling traffic, etc.) from UE 903 via the air interface, and may communicate the traffic to UPF/PGW-U 935, and/or one or more other devices or networks. Similarly, RAN 910 may receive traffic intended for UE 903 (e.g., from UPF/PGW-U 935, SGW 917, and/or one or more other devices or networks) and may communicate the traffic to UE 903 via the air interface.

AMF 915 may include one or more devices, systems, Virtualized Network Functions (“VNFs”), etc., that perform operations to register UE 903 with the 5G network, to establish bearer channels associated with a session with UE 903, to hand off UE 903 from the 5G network to another network, to hand off UE 903 from the other network to the 5G network, manage mobility of UE 903 between RANs 910 and/or gNBs 911, and/or to perform other operations. In some embodiments, the 5G network may include multiple AMFs 915, which communicate with each other via the N14 interface (denoted in FIG. 9 by the line marked “N14” originating and terminating at AMF 915).

MME 916 may include one or more devices, systems, VNFs, etc., that perform operations to register UE 903 with the EPC, to establish bearer channels associated with a session with UE 903, to hand off UE 903 from the EPC to another network, to hand off UE 903 from another network to the EPC, manage mobility of UE 903 between RANs 912 and/or eNBs 913, and/or to perform other operations.

SGW 917 may include one or more devices, systems, VNFs, etc., that aggregate traffic received from one or more eNBs 913 and send the aggregated traffic to an external network or device via UPF/PGW-U 935. Additionally, SGW 917 may aggregate traffic received from one or more UPF/PGW-Us 935 and may send the aggregated traffic to one or more eNBs 913. SGW 917 may operate as an anchor for the user plane during inter-eNB handovers and as an anchor for mobility between different telecommunication networks or RANs (e.g., RANs 910 and 912).

SMF/PGW-C 920 may include one or more devices, systems, VNFs, etc., that gather, process, store, and/or provide information in a manner described herein. SMF/PGW-C 920 may, for example, facilitate in the establishment of communication sessions on behalf of UE 903. In some embodiments, the establishment of communications sessions may be performed in accordance with one or more policies provided by PCF/PCRF 925.

PCF/PCRF 925 may include one or more devices, systems, VNFs, etc., that aggregate information to and from the 5G network and/or other sources. PCF/PCRF 925 may receive information regarding policies and/or subscriptions from one or more sources, such as subscriber databases and/or from one or more users (such as, for example, an administrator associated with PCF/PCRF 925).

AF 930 may include one or more devices, systems, VNFs, etc., that receive, store, and/or provide information that may be used in determining parameters (e.g., quality of service parameters, charging parameters, or the like) for certain applications.

UPF/PGW-U 935 may include one or more devices, systems, VNFs, etc., that receive, store, and/or provide data (e.g., user plane data). For example, UPF/PGW-U 935 may receive user plane data (e.g., voice call traffic, data traffic, etc.), destined for UE 903, from DN 950, and may forward the user plane data toward UE 903 (e.g., via RAN 910, SMF/PGW-C 920, and/or one or more other devices). In some embodiments, multiple UPFs 935 may be deployed (e.g., in different geographical locations), and the delivery of content to UE 903 may be coordinated via the N9 interface (e.g., as denoted in FIG. 9 by the line marked “N9” originating and terminating at UPF/PGW-U 935). Similarly, UPF/PGW-U 935 may receive traffic from UE 903 (e.g., via RAN 910, SMF/PGW-C 920, and/or one or more other devices), and may forward the traffic toward DN 950. In some embodiments, UPF/PGW-U 935 may communicate (e.g., via the N4 interface) with SMF/PGW-C 920, regarding user plane data processed by UPF/PGW-U 935.

HSS/UDM 940 and AUSF 945 may include one or more devices, systems, VNFs, etc., that manage, update, and/or store, in one or more memory devices associated with AUSF 945 and/or HSS/UDM 940, profile information associated with a subscriber. AUSF 945 and/or HSS/UDM 940 may perform authentication, authorization, and/or accounting operations associated with the subscriber and/or a communication session with UE 903.

DN 950 may include one or more wired and/or wireless networks. For example, DN 950 may include an Internet Protocol (“IP”)-based PDN, a wide area network (“WAN”) such as the Internet, a private enterprise network, and/or one or more other networks. UE 903 may communicate, through DN 950, with data servers, other UEs UE 903, and/or to other servers or applications that are coupled to DN 950. DN 950 may be connected to one or more other networks, such as a public switched telephone network (“PSTN”), a public land mobile network (“PLMN”), and/or another network. DN 950 may be connected to one or more devices, such as content providers, applications, web servers, and/or other devices, with which UE 903 may communicate.

The client-side router 951 may include one or more devices, systems, VNFs, etc., that perform one or more operations described herein. For example, the client-side router 951 may monitor and/or analyze video stream chunks and/or statuses associated with video stream chunks to check for quality issues and/or may deliver video stream chunks to UE 903.

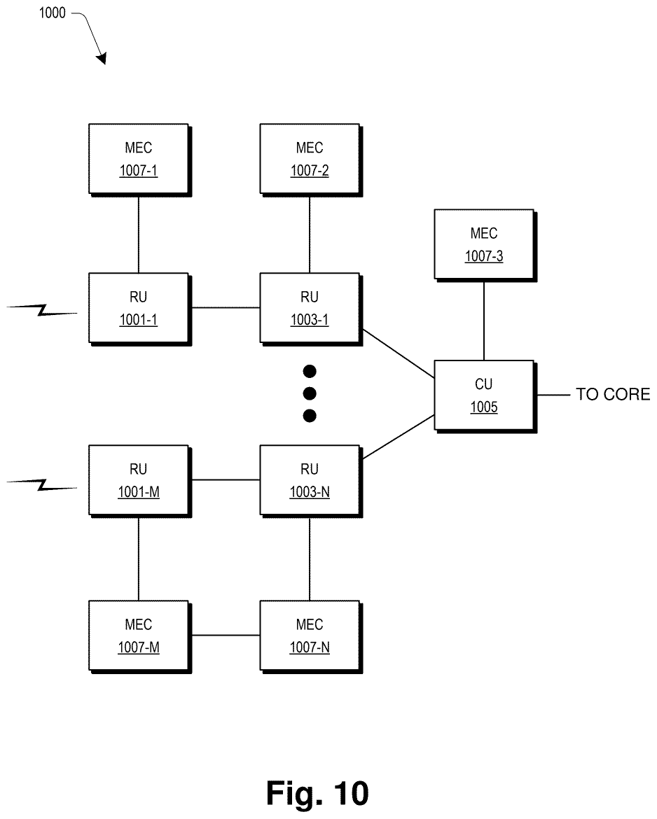

FIG. 10 illustrates an example Distributed Unit (“DU”) network 1000, which may be included in and/or implemented by one or more RANs (e.g., RAN 910, RAN 912, or some other RAN). In some embodiments, a particular RAN may include one DU network 1000. In some embodiments, a particular RAN may include multiple DU networks 1000. In some embodiments, DU network 1000 may correspond to a particular gNB 911 of a 5G RAN (e.g., RAN 910). In some embodiments, DU network 1000 may correspond to multiple gNBs 911. In some embodiments, DU network 1000 may correspond to one or more other types of base stations of one or more other types of RANs. As shown, DU network 1000 may include Central Unit (“CU”) 1005, one or more Distributed Units (“DUs”) 1003-1 through 1003-N (referred to individually as “DU 1003,” or collectively as “DUs 1003”), and one or more Radio Units (“RUs”) 1001-1 through 1001-M (referred to individually as “RU 1001,” or collectively as “RUs 1001”).

CU 1005 may communicate with a core of a wireless network (e.g., may communicate with one or more of the devices or systems described above with respect to FIG. 9, such as AMF 915 and/or UPF/PGW-U 935). In the uplink direction (e.g., for traffic from UEs UE 903 to a core network), CU 1005 may aggregate traffic from DUs 1003, and forward the aggregated traffic to the core network. In some embodiments, CU 1005 may receive traffic according to a given protocol (e.g., Radio Link Control (“RLC”)) from DUs 1003, and may perform higher-layer processing (e.g., may aggregate/process RLC packets and generate Packet Data Convergence Protocol (“PDCP”) packets based on the RLC packets) on the traffic received from DUs 1003.

In accordance with some embodiments, CU 1005 may receive downlink traffic (e.g., traffic from the core network) for a particular UE 903, and may determine which DU(s) 1003 should receive the downlink traffic. DU 1003 may include one or more devices that transmit traffic between a core network (e.g., via CU 1005) and UE 903 (e.g., via a respective RU 1001). DU 1003 may, for example, receive traffic from RU 1001 at a first layer (e.g., physical (“PHY”) layer traffic, or lower PHY layer traffic), and may process/aggregate the traffic to a second layer (e.g., upper PHY and/or RLC). DU 1003 may receive traffic from CU 1005 at the second layer, may process the traffic to the first layer, and provide the processed traffic to a respective RU 1001 for transmission to UE 903.

RU 1001 may include hardware circuitry (e.g., one or more RF transceivers, antennas, radios, and/or other suitable hardware) to communicate wirelessly (e.g., via an RF interface) with one or more UEs UE 903, one or more other DUs 1003 (e.g., via RUs 1001 associated with DUs 1003), and/or any other suitable type of device. In the uplink direction, RU 1001 may receive traffic from UE 903 and/or another DU 1003 via the RF interface and may provide the traffic to DU 1003. In the downlink direction, RU 1001 may receive traffic from DU 1003, and may provide the traffic to UE 903 and/or another DU 1003.

RUs 1001 may, in some embodiments, be communicatively coupled to one or more Multi-Access/Mobile Edge Computing (“MEC”) devices, referred to sometimes herein simply as (“MECs”) 1007. For example, RU 1001-1 may be communicatively coupled to MEC 1007-1, RU 1001-M may be communicatively coupled to MEC 1007-M, DU 1003-1 may be communicatively coupled to MEC 1007-2, DU 1003-N may be communicatively coupled to MEC 1007-N, CU 1005 may be communicatively coupled to MEC 1007-3, and so on. MECs 1007 may include hardware resources (e.g., configurable or provisionable hardware resources) that may be configured to provide services and/or otherwise process traffic to and/or from UE 903, via a respective RU 1001.

For example, RU 1001-1 may route some traffic, from UE 903, to MEC 1007-1 instead of to a core network (e.g., via DU 1003 and CU 1005). MEC 1007-1 may process the traffic, perform one or more computations based on the received traffic, and may provide traffic to UE 903 via RU 1001-1. In this manner, ultra-low latency services may be provided to UE 903, as traffic does not need to traverse DU 1003, CU 1005, and an intervening backhaul network between DU network 1000 and the core network. In some embodiments, MEC 1007 may include, and/or may implement some or all of the functionality described above with respect to the client-side router 951.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
controlling services provided to a first device in a first group of devices based on a first service allocation for the first group during a first portion of a first service interval;
controlling services provided to a second device in a second group of devices based on a second service allocation for the second group during the first portion of the first service interval;
determining a first individual usage metric for the first device for the first service interval;
determining a first group usage metric for the first group of devices for the first service interval;
transferring the first device from the first group of devices to the second group of devices responsive to the first group usage metric exceeding the first service allocation; and
controlling services provided to the first device in the second group based on the second service allocation during a second portion, different than the first portion, of the first service interval.

2. The method of claim 1, comprising:
controlling services provided to the first device in the second group based on the second service allocation during a second service interval after the first service interval.

3. The method of claim 1, wherein determining the first individual usage metric comprises:
adding a real usage metric during the first portion of the first service interval and an estimated usage metric during the second portion of the first interval.

4. The method of claim 1, comprising:
controlling services provided to a third device in the second group during the first portion of the first service interval;
determining a second individual usage metric for the third device for the first service interval;
transferring the third device to the first group based on the second individual usage metric; and
controlling services provided to the third device in the first group during the second portion of the first interval.

5. The method of claim 1, wherein:
controlling the services comprises:
controlling at least one of a quality of service parameter or a bandwidth parameter.

6. The method of claim 1, comprising:
determining a second service allocation for the first group of devices and a third service allocation for the second group of devices assuming a transfer of the first device; and
allowing the transfer of the first device responsive to a sum of the second service allocation and the third service allocation not exceeding a predetermined balancing limit.

7. The method of claim 1, comprising:
triggering a rebalancing process for determining the first individual usage metric and the first group usage metric, and transferring the first device a predetermined time interval before an end of the first service interval.

8. The method of claim 1, wherein:
transferring the first device comprises transferring the first device responsive to the first group usage metric exceeding the first service allocation and a second group usage metric for the second group of devices determined after transferring the first device being less than a second service allocation.

9. A system, comprising:
a first database configured to store usage data for devices;
a provisioning system configured to:
control services provided to a first device in a first group of the devices based on a first service allocation for the first group during a first portion of a first service interval; and
control services provided to a second device in a second group of the devices based on a second service allocation for the second group during the first portion of the first service interval; and
a service usage allocation unit configured to:
determine a first individual usage metric for the first device for the first service interval based on the usage data;
determine a first group usage metric for the first group of devices for the first service interval based on the usage data; and
transfer the first device from the first group of devices to a second group of devices responsive to the first group usage metric exceeding the first service allocation, wherein:
the provisioning system is configured to control services provided to the first device in the second group based on the second service allocation during a second portion, different than the first portion, of the first service interval.

10. The system of claim 9, wherein:
the provisioning system is configured to:
control services provided to the first device in the second group based on the second service allocation during a second service interval after the first service interval.

11. The system of claim 9, wherein first individual usage metric comprises:
a real usage metric during the first portion of the first service plus and an estimated usage metric during the second portion of the first interval.

12. The system of claim 9, wherein:
the provisioning system is configured to:
control services provided to a third device in the second group during the first portion of the first service interval;
the service usage allocation unit is configured to:
determine a second individual usage metric for the third device for the first service interval; and
transfer the third device to the first group based on the second individual usage; and
the provisioning system is configured to:
control services provided to the third device in the first group during the second portion of the first interval.

13. The system of claim 9, wherein:
the provisioning system is configured to:
control at least one of a quality of service parameter or a bandwidth parameter of the first device.

14. The system of claim 9, wherein:
the service usage allocation unit is configured to:
determine a second service allocation for the first group of devices and a third service allocation for the second group of devices assuming a transfer of the first device; and
allow the transfer of the first device responsive to a sum of the second service allocation and the third service allocation not exceeding a predetermined balancing limit.

15. The system of claim 9, comprising:
a scheduler configured to trigger a rebalancing process for determining the first individual usage metric and the first group usage metric, and transfer the first device a predetermined time interval before an end of the first service interval.

16. A non-transitory computer-readable medium, storing instructions thereon that when executed by a processor cause the processor to:
control services provided to a first device in a first group of devices based on a first service allocation for the first group during a first portion of a first service interval;
control services provided to a second device in a second group of devices based on a second service allocation for the second group during the first portion of the first service interval;
determine a first individual usage metric for the first device for the first service interval;
determine a first group usage metric for the first group of devices for the first service interval;
transfer the first device from the first group of devices to a second group of devices responsive to the first group usage metric exceeding the first service allocation; and
control services provided to the first device in the second group based on the second service allocation during a second portion, different than the first portion, of the first service interval.

17. The medium of claim 16, wherein the processor is configured to:
control services provided to the first device in the second group based on the second service allocation during a second service interval after the first service interval.

18. The medium of claim 16, wherein the processor is configured to:
control services provided to a third device in the second group during the first portion of the first service interval;
determine a second individual usage metric for the third device for the first service interval;
transfer the third device to the first group based on the second individual usage metric; and
control services provided to the third device in the first group during the second portion of the first interval.

19. The medium of claim 16, wherein the processor is configured to:
controlling the services by:
controlling at least one of a quality of service parameter or a bandwidth parameter.

20. The medium of claim 16, wherein the processor is configured to:
determine a second group usage metric for the first group of devices and a third group usage metric for the second group of devices assuming a transfer of the first device; and
allow the transfer of the first device responsive to a sum of the second group usage metric and the third group usage metric not exceeding a predetermined balancing limit.
